(19) United States
(12) Patent Application Publication
(10) Pub. No.: US 2005/0217281 A1
(43) Pub. Date: Oct. 6, 2005

(54) Method for the reliquefaction of gas

(75) Inventors: Robert Adler, Gerasdorf (AT); Georg Siebert, Wien (AT)

Correspondence Address: CROWELL & MORING LLP;INTELLECTUAL PROPERTY GROUP, P.O. BOX 14300, WASHINGTON, DC, 20044-4300, US

(73) Assignee: Linde Aktiengesellschaft, Wiesbaden (DE)

(21) Appl. No.: 11/047,775

(22) Filed: Feb. 2, 2005

(30) Foreign Application Priority Data
Feb. 3, 2004 (DE) 10 2004 005 305.7

(51) Int. Cl. F17C 5/02; F17C 3/10; F25J 1/00

(52) U.S. Cl. 62/48.2; 62/47.1

(57) ABSTRACT

A method for the reliquefaction of the gas phase occurring in a storage tank includes the step of warming, compressing, cooling and expanding a reliquefying gas stream after its removal from the storage tank against itself for the purpose of reliquefaction, wherein only a partial flow of the gas stream removed from the storage tank is fed to a compressor.

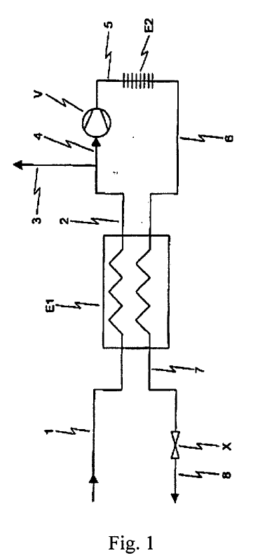

### BACKGROUND AND SUMMARY OF THE INVENTION

This application claims the priority of Federal Republic of Germany Patent Document No. 10 2004 005 305.7, filed Feb. 3, 2004, the disclosure of which is expressly incorporated by reference herein.

The invention relates to a method for the reliquefaction of the gas phase occurring in a storage container, in which the gas stream to be reliquefied is warmed against itself after removal from the storage container, compressed, cooled, and expanded for the purpose of reliquefaction.

Methods for liquefaction are employed, for example, in the storage of cryogenic gases or media, such as liquid hydrogen. Regardless of the storage tank construction selected in an individual case, it is inevitable that, due to the incidence of heat on the stored medium, some vaporization will occur. Now, if one is to prevent vaporized gaseous medium from escaping from a pressurized storage container, the reliquefaction of the developing gas phase is necessary.

The current reliquefaction methods consist essentially of a heat exchanger, a compressor, an ambient air cooler and an expansion machine. If such a reliquefaction method is used, for example, in combination with the storage of liquid hydrogen, then when the evaporated hydrogen is removed from the hydrogen storage tank, the hydrogen is at the storage pressure and the corresponding ebullition temperature. At 3 bars, the temperature is 24 K.

The removed gaseous hydrogen is first heated in the heat exchanger against a compressed hydrogen stream, which will be discussed at greater length later. Here an energy exchange takes place between the removed hydrogen stream and the compressed high-pressure hydrogen stream. Since both mass flows are of the same size, an energy exchange can take place only in a 1:1 ratio. In this case the temperature difference necessary for the chosen heat exchanger, as well as the dependency on pressure, must be taken into consideration. The temperature prevailing in the storage tank cannot be reached in this case.

To the output of the above-described heat exchanger there is connected a compressor, which compresses the heated hydrogen stream to the desired process pressure. The heat thus developed is removed through an ambient air condenser connected to the output of the compressor. After passing through the ambient air condenser, the compressed hydrogen stream is fed again to the heat exchanger and therein it is cooled against the gas stream that is taken from the storage tank and is to be heated. The compressed hydrogen stream is under the pressure of 13 to 400 bar, although even higher pressure can be achieved. Thereupon the hydrogen stream thus cooled is expanded using an expansion apparatus—preferably an expansion turbine—to the desired pressure of the storage tank and reliquefied. The chosen expansion apparatus permits the achievement of an isotropic expansion, whereby a liquefaction at least of a portion of the compressed hydrogen stream occurs.

The portion of the gas stream that has not been reliquefied in the reliquefaction process is fed together with its liquid portion back to the storage tank. Since the above-described reliquefaction process is operated continuously as a rule, this non-liquefied content, together with the gas stream developing in the head space of the storage tank and withdrawn therefrom, is fed back again into the reliquefaction process.

An object of the present invention is to provide a method for the reliquefaction of the gas phase occurring in a storage tank, which avoids the above-described disadvantages.

To achieve the object a method is proposed in which only a portion of the gas stream taken from the storage tank is fed to the compressor.

In contrast to the known procedures, it is not the entire gas stream taken from the storage tank that is delivered to the compressor and thus ultimately to the reliquefaction process, but only a portion of this gas stream that is taken from the storage tank.

The portion of the gas stream taken from the tank and not delivered to the compressor is preferably delivered or subjected to an energy converting process, a fuel cell, for example, a Stirling engine, a direct vapor producer, a vapor process, a gas turbine process, and/or to a storage means.

Other objects, advantages and novel features of the present invention will become apparent from the following detailed description of the invention when considered in conjunction with the accompanying drawings.

### BRIEF DESCRIPTION OF THE DRAWINGS

The lone FIGURE shows a system used in the present invention.

### DETAILED DESCRIPTION OF THE DRAWINGS

Represented in the FIGURE is a take-off line 1 through which a gas stream is withdrawn from a storage tank and delivered to the heat exchanger E1. In the heat exchanger E1 the gas stream is heated by heat exchange with the compressed gas stream fed through line 6 to the heat exchanger E1 (which will be discussed in greater detail later on) and then withdrawn through line 2 from the heat exchanger E1. Then a separation takes place of the heated gas stream in line 2 into a first partial steam which is fed through line 4 to the single-stage or multi-stage compressor V, and into a second partial stream which is withdrawn through line 3 and, as already mentioned, sent or subjected preferably to an energy converting process, such as a fuel cell, a Stirling engine, a direct steam generator, a steam process, a gas turbine process and/or a storage means. The energy obtained from an energy converting process is used, for example, for driving the compressor V. This procedure makes sense especially in an automotive application of the process of the invention.

The first compressed partial stream is fed, after being compressed to a pressure between 13 and 400 bar through line 5 to an air cooler E2 and cooled therein. Then the compressed partial stream of the gas stream taken from the storage tank is fed again through line 6 to the above-mentioned heat exchanger E1, cooled in the heat exchanger E1 against the entire gas stream taken from the storage tank and then fed through line 7 to a throttle device X. In the throttle device X an isenthalpic expansion is then performed to the desired pressure of the storage tank, to which the gas that is present in liquid form after the expansion is fed through line 8.

In contrast to the reliquefaction processes of the state of the art, an expansion turbine can now be avoided. In its place is a far more cost-effective throttling device X, such as an expansion valve. Basically, however, the use of an expansion turbine is still also possible.

Since a partial stream 3 of the warmed gas stream is now withdrawn ahead of the compressor V and thus is not compressed by the compressor V, and then is cooled in the heat exchanger E1, the mass flow ratio in the heat exchanger E1 changes with respect to the reliquefaction process, in which the mass flow ratio in the heat exchanger E1 amounts to one. Thus specifically more energy can be transferred from the compressed gas stream—which has a smaller gas flow—to the hydrogen stream that is drawn from the storage tank and has a greater mass flow. The “limit” in this heat exchange is dependent upon the heat exchanger selected and the temperature at entry of the gas stream drawn from the storage tank. The ratio, however, can now be influenced by the removal of a portion of the gas stream ahead of the compression V; the greater the gas stream 3 that is not fed to the compressor V, the greater is the mass flow ratio at the heat exchanger E1.

In the process of the invention for reliquefaction, the same compressor and ambient air cooler can be used which are used in the methods of the state of the art. Under otherwise identical marginal conditions, the power requirement of the compressor is reduced in the case of the method of the invention by the absence of the mass flow of the partial stream taken ahead of the compressor.

While in the reliquefaction processes of the state of the art no isenthalpic expansion can be obtained that permits a sufficiently great fluid content to be achieved, it is now possible in the method of the invention for the reliquefaction of a gas stream.

The method of the invention therefore permits an increase in the overall efficiency, the obtaining of a greater liquid part after the throttling or expansion, as well as the possibility of isenthalpic expansion. To be economical, it furthermore does not require necessarily great mass flows. Furthermore, the construction cost is reduced since the formerly required expansion machines can now be eliminated.

Especially in the automotive area (liquid hydrogen) storage tanks having a comparatively small storage capacity can be used; these comparatively small storage capacities result in relatively low evaporation losses and consequently relatively small mass flows. Conventional reliquefaction methods are not suitable for the reliquefaction of such small mass flows.

The method of the invention is therefore especially appropriate for use in the automotive field, since for one thing it works effectively also in the case of low mass flows, and for another thing it has a definitely lower total weight than conventional methods. This weight reduction results from the elimination of the formerly necessary expansion machine, as well as the fact that, on the basis of the efficiency increase achieved, a lesser mass flow needs to be circulated, resulting in a reduction of the structural sizes of the previously described components, such as compressor, heat exchanger, etc.

In the case of hydrogen powered motor vehicles the problem heretofore has been that, on account of the inevitable vapor losses from the liquid hydrogen storage tank, the service life of such vehicles is presently limited to no more than 2 weeks. In an embodiment of the method of the invention in the automotive field, substantially longer service lives are achieved, especially when the gas stream drawn from ahead of the compressor is fed, for example, to a fuel cell and the energy obtained in the fuel cell is used to power the compressor.

Besides, the method of the invention can of course also be used to advantage in all other known applications, such as for example in (liquid hydrogen) storage tanks at hydrogen filling stations.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A method for the reliquefaction of the gas phase occurring in a storage tank, comprising:
warming, compressing, cooling and expanding a reliquefying gas stream after its removal from the storage tank against itself for the purpose of reliquefaction, wherein only a partial flow of the gas stream removed from the storage tank is fed to a compressor.

2. The method according to claim 1, further comprising feeding a partial flow of the gas stream, which is removed from the storage tank but not fed to the compressor, to an energy converting process.

3. The method according to claim 2, wherein the energy converting process is at least one of a fuel cell, a Stirling motor, a direct vapor generator, a vapor process, a gas turbine process and a storage.

4. The method according to claim 2, comprising worming the gas stream removed from the storage tank against a compressed partial stream of the removed gas stream.

5. The method according to claim 4, further comprising using energy obtained in the energy converting process to drive the gas stream removed from the storage tank.

6. The method according to claim 5, wherein the reliquefying gas stream is hydrogen.

7. The method according to claim 2, further comprising using energy obtained in the energy converting process to drive the gas stream removed from the storage tank.

8. The method according to claim 1, comprising worming the gas stream removed from the storage tank against a compressed partial stream of the removed gas stream.

9. The method according to claim 1, wherein the reliquefying gas stream is hydrogen.
